(19) United States
(12) Patent Application Publication
(10) Pub. No.: US 2014/0285005 A1
(43) Pub. Date: Sep. 25, 2014

(54) Solar Power Platform Capable of Charging During Transport

(71) Applicant: Eric P. Casteel, Pittsburgh, PA (US)

(72) Inventor: Eric P. Casteel, Pittsburgh, PA (US)

(21) Appl. No.: 14/207,449

(22) Filed: Mar. 12, 2014

Related U.S. Application Data
(60) Provisional application No. 61/777,262, filed on Mar. 12, 2013.

(51) Int. Cl. H02J 7/35; F21S 9/03

(52) U.S. Cl. CPC H02J 7/35; F21S 9/03
USPC 307/23; 320/101

(57) ABSTRACT

A mobile power platform can start storing energy to its battery array while being transported to an end use location. The platform, on a towable trailer, uses an array of photovoltaic cells, in panels that fold for transport before unfolding for full deployment at its user location. The system can be positioned in the direction of the sun with efficient, cost effective means. Optional additions to the platform include a mast with windmill and/or floodlight tower, a stand by/back-up generator, and kinetic power assist.

### CROSS-REFERENCE TO RELATED APPLICATION

This is a perfection of U.S. Provisional Application Ser. No. 61/777,262, filed on Mar. 12, 2013, the disclosure of which is fully incorporated by reference herein.

### BACKGROUND OF THE INVENTION

1. Field of the Invention

This invention relates to a mobile power platform (or somewhat portable power assembly) having the following components: a solar energy system, multiple batteries, a back-up generator, optional wind energy system, and optional floodlighting system. These components are constructed on a lightweight platform for transporting to a location by truck or other vehicle, using at that location and transporting away or to another location after use.

2. Description of Relevant References

Methods and devices for providing remote power using hybrid, renewable energy sources are known. U.S. Published Application No. 2003/0105556, for example, discloses a method and device for using wind to supply uninterrupted power to a location not served by a power grid. However, that invention only uses wind energy that may be stored as compressed air and it does not provide for portability.

U.S. Publication Application No. 2012/0201016 shows a solar-powered device with a mobile base unit, a power module that converts solar energy to electrical current and a lighting module powered, directly or indirectly, from that electrical current. By contrast, the present invention uses a photovoltaic solar array, standby generator and optional wind turbine to charge its battery system. In turn, that charged system provides the source of all power for running outdoor floodlights and/or an AC electrical panel.

U.S. Pat. No. 4,206,608 discloses a system for storing and generating electricity using solar, wind, and wave energy. But, it has no reference to portability.

U.S. Pat. No. 4,261,329 discloses a portable housing module with a thermal unit that extracts heat from the sun to a heat exchanger and a photovoltaic unit that extracts photons to create electricity. That module is not integral to its trailer, however. It merely carries the unit from point A to point B.

U.S. Pat. Nos. 4,551,980 and 4,982,569 disclose hybrid systems for generating power using photovoltaic and harnessed wind energy to charge a battery and supply current to an electrical load.

U.S. Pat. No. 5,969,501 discloses a box-like portable solar power system that is not severable from its trailer. It uses adjustable support braces to position its solar array. The present invention, on the other hand uses a DC electric linear actuator for solar array positioning.

U.S. Pat. No. 6,101,750 discloses a “portable message sign” that harnesses solar energy for powering its road sign.

U.S. Pat. No. 6,559,552 discloses an electric generating installation using rain, wind, wave, and solar energy. It relies on at least one of the sources being active for continuous energy generation but does not describe portability.

U.S. Pat. No. 7,230,819 discloses a method of transporting and assembling a power station. It accesses received power in a plurality of different electrical configurations and stores its power generating devices and coupling components inside a shipping container during transport.

U.S. Pat. No. 7,469,541 shows a transportable platform of substantial weight for wind stability. It serves as an energy storage system using batteries for back-up power. The present invention, by contrast, uses its charged batteries for primary AC power output.

Finally, U.S. Pat. No. 8,299,645 discloses a short, pull trailer with a wind power generating device having an automatically deploying mast system.

No one reference addresses the need to provide continuous, reliable, and renewable energy power to remote sites on a lightweight portable trailer while being able to charge its battery units during transport.

### SUMMARY OF THE INVENTION

The present invention comprises a mobile power platform which can start storing energy to its batteries while in transport. It uses an array of photovoltaic cells in panels that fold for easier transport before fully deploying at its designated use site. That solar panel array is preferably greater than 640 watts and optimally between 1000 and 32000 watts. The system can be positioned in the direction of the sun with efficient, cost effective means. The assembly further comprises a stand by/back-up generator powered by gas, diesel, propane or natural gas along with several batteries in a weatherproof box for storing the energy generated by its various power energy units. The assembly may further include a communications system.

The lightweight assembly is transportable to locations where energy is needed, including remote locations. It includes an inverter for providing electric power to a weatherproof panel permanently mounted onto this transportable assembly/trailer unit.

The invention further comprises a method for providing portable, renewable energy. That method comprises the steps of: providing the aforementioned power system, disposing that system on a transportable platform, and commencing the storage of usable energy while transporting that system to an end user site. The platform system easily transports to one or more locations where energy is required, even remote locations. It is relatively lightweight yet durable. It enables connecting for the extraction of energy stored in a plurality of rechargeable batteries.

A primary object of the present invention is to provide a renewable energy unit that is capable of starting to store energy while in transit. Other objects, advantages and novel features of this invention will be set forth in part in the detailed description to follow, taken in conjunction with the accompanying photographs of a working prototype.

### BRIEF DESCRIPTION OF THE DRAWINGS

FIG. 1 is a left side perspective view of one preferred embodiment folded for transport on its trailer with an optional floodlight rack/wind turbine mast added;

FIG. 2 is a left side perspective view of the trailer unit from FIG. 1 fully deployed and its floodlight rack/wind turbine mast raised into position;

FIG. 3 is a partial right perspective showing the “rear” or underside view of the fully deployed unit from FIGS. 1 and 2;

FIG. 4 is a chart comparing fuel costs of one representative embodiment of this invention (internally referred to as the MP-4000 Solar unit) alone and with an optional wind turbine mast added versus the costs for a typical diesel generator-powered alternative over a five-year period;

FIG. 5 is a perspective view focusing on one configuration of battery storage according to this invention;

FIG. 6 is a perspective view showing one arrangement of peripheral hardware within a cabinet according to this invention;

FIG. 7 is a perspective view showing one version of kinetic energy generator between the trailer wheels of one optional embodiment; and

FIG. 8 is a perspective view showing, in detail, one version of lift station and pendant station (w/ key switch) according to this invention.

### DESCRIPTION OF PREFERRED EMBODIMENTS

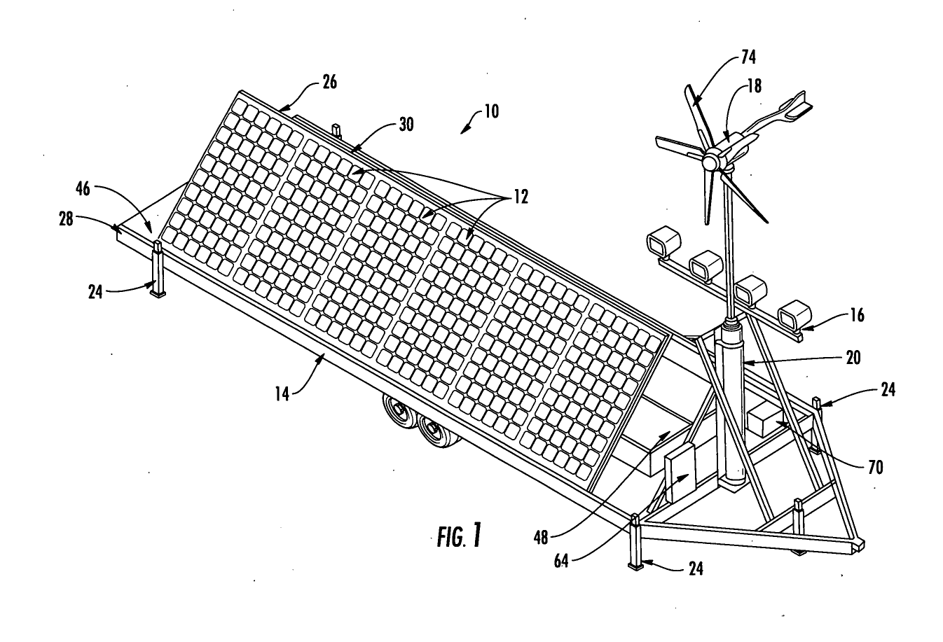

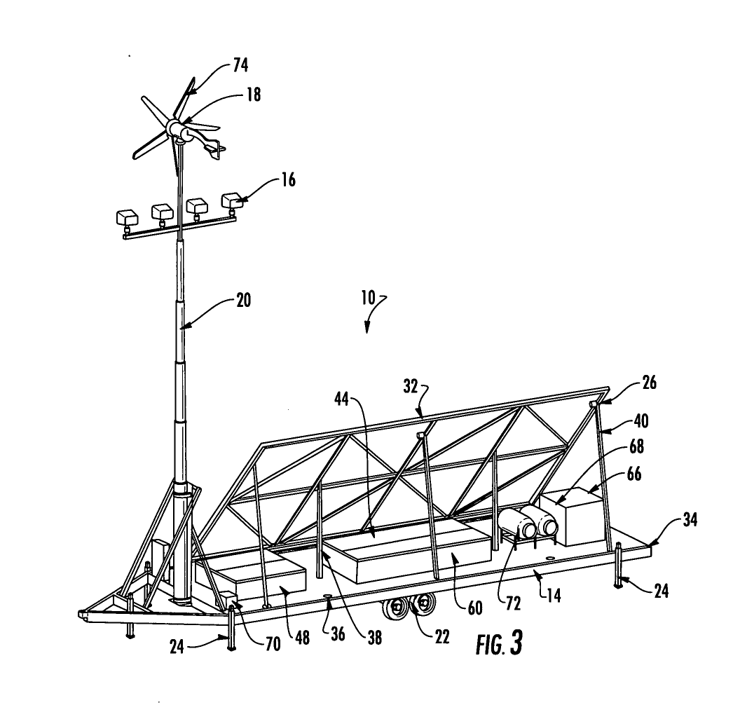

Referring to the accompanying FIGS. 1 through 3, there is a shown a mobile (or semi-portable, by towing) power platform, generally 10, with an AC (and, optionally 12, 24 or 48 VDC) power source that uses a plurality of foldable photovoltaic solar panels 12 hingedly attached to a flat towable trailer 14. Optionally, it includes one or more racks of floodlights 16, a small wind turbine component 18, one or both that attach to an extendible pole or mast 20 and/or a kinetic charger optional mechanism 22. Note that, when referring to any numerical part size and/or power delivery capacity, representative values may be expressed as precise numbers or between a range of numbers (a minimum to maximum). All such values are truly representative and this invention should not be restricted to a device only X feet long, weighing Y pounds and products Z units of power. Furthermore, when any range is cited below, it is to be understood that every such range includes every value between the stated minimum and maximum. For instance, a panel measuring between about 24 to 42 inches wide, each, would also cover panels that are about 24½, 25 and 27¾ inches to about 35, 37 or 39.95 inches wide, said panels also being between about 40 to 66 inches long.

One particular embodiment includes a 22 foot long, 102 inches wide “deckover” dual axle trailer 14 with a GVWR of 7000 lbs. That trailer includes 4 drop-leg leveling jacks 24 at its four corners (though only two are visible in these views). Bubble levels (not shown) may be permanently mounted onto the front and rear of the trailer frame for assisting with manual leveling at each end user site.

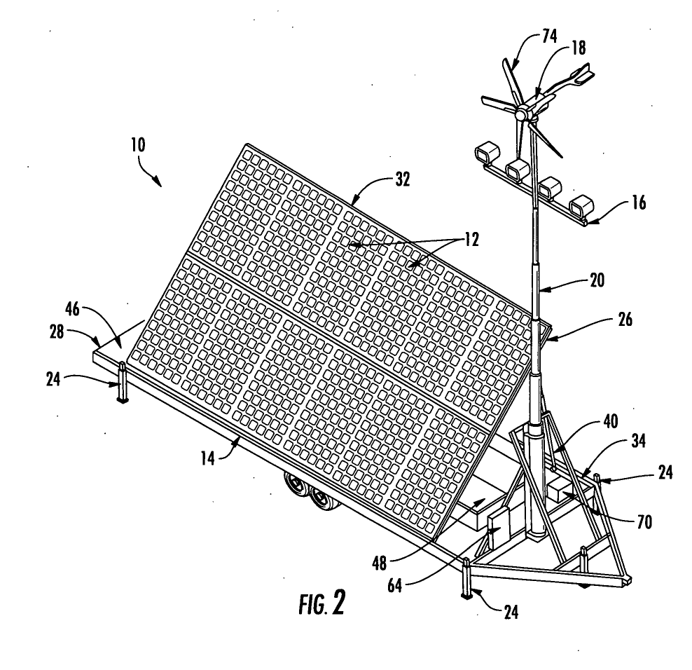

An aluminum frame 26 holds a plurality of photovoltaic solar panels 12. That frame 26 is permanently attached to one long edge 28 of trailer 14. Frame 26 includes a hinge 30 that runs lengthwise over the center width W of trailer 14. The unattached side 32 of that frame 26 secures to an opposite (long) trailer edge 34 with two spring loaded, locking pins 36. After releasing these pins 36, the photovoltaic solar panels 12 on hinged frame 26 can be positioned to an open or fully deployed state (see FIG. 2), using 12 to 48 VDC electric screw actuators 38. Preferably, the proper positioning of frame 26 is controlled by a pendant station 42 connected to the lift controller cabinet 70 at or towards the front of trailer 14. Support posts 40 are used to stabilize the frame 26 in the fully deployed fixed position state.

As best seen in FIGS. 1, 2 and 3, the hinged frame 26 of solar panels 12 stores in an “A” configuration during the transport of trailer 14. It then opens to a flat plane for operation (i.e., when stationary). An inclinometer (not shown) mounted on hinged frame 26 shows the angle of the solar panels for operational optimization.

In the accompanying FIGS., the representative device 10 is shown with two rows of panels, with six panels per row. It is to be understood that fewer or greater numbers of panels may be joined together in alternate embodiments of this invention depending on trailer size, towing weights and/or power output needs of the customer (either a purchaser or event lessee). One representative manufacturer of such panels is SolarWorld (company), though substitute models are also made and sold by SunPower, or LG Solar.

Preferably, the solar panels 12 for system 10 secure to both sides of hinged frame 26 with weather stripping and aluminum “C” and “I” channels. All of said panels electrically connect to a fused combiner box 44 mounted on the main or top deck 46 of trailer 14.

There is a power controller cabinet 48 mounted onto deck 46 of trailer 14. It contains the photovoltaic solar battery charger 50, DC-to-AC inverter 52, gateway communication controller 76, power fuse block for AC and DC electrical terminations 58, optional wind turbine controller 54, optional kinetic generator controller 56 and optional GSM communication modem 78.

A power storage cabinet 60 also mounts to trailer deck 46. It contains a “bank” of four or more 225 amp-hour batteries 62 in a 12, 24 or 48 VDC configuration. An outlet (now shown) is provided on the outside of power storage cabinet 60 for providing 12, 24 or 48 VDC power directly to DC devices or to charge the aforementioned battery bank with an external charger (not shown).

Within power storage cabinet 60, the batteries 62 are connected to electrical power distribution blocks (not shown) with fused connections (not shown) for each positive electrical termination. The batteries 62 connected through the power distribution blocks (now shown) are electrically connected to the power fuse block for AC and DC electrical terminations 58 in the power controller cabinet 48.

The solar panels 12 are electrically connected to the fused combiner box 44. The fused combiner box 44 is electrically connected to the photovoltaic solar charger 50 in the power controller cabinet 48. The photovoltaic solar charger 50 is electrically connected to the batteries 62 through the power fuse block for AC and DC electrical terminations 58 in the power controller cabinet 48.

The DC-to-AC inverter 52 in the power controller cabinet 48 electrically connects through the power fuse block for AC and DC electrical terminations 58 to that same bank of batteries 62 in power storage cabinet 60 and an electrical power panel 64 mounted to the front of trailer 14. One embodiment of inverter 52 is designed for continuous 4000 Watt output at 120/240 or 230 VAC for at least about 18 hours when the batteries in bank 62 are fully charged.

A standby generator 66 may be mounted to the top deck 46 of trailer 14 to provide up to 4000 Watt output at 120/240 VAC when the voltage for battery bank 62 drops below a configurable threshold voltage setting. The configurable threshold voltage setting determines the automatic startup and shutdown of the standby generator 66 through the generator controller cabinet 68. When standby generator 66 is running, the electrical load is handled by the generator while also charging battery bank 62.

A system status display in the lift controller cabinet 70 mounts to the front of trailer 14. It provides information on the charge level for battery bank 62 and its inverter 52 output capacity. Preferably, that display cabinet 68 also includes an emergency shutdown button (not shown). An optional cellular communication modem 78 can be included within power controller cabinet 48 for remote monitoring and reporting on overall performance of system 10.

In FIG. 2, an optional telescoping mast 20 with outdoor flood lighting 16 is mounted to the front of trailer 14. Mast 20 can be raised or lowered with the pendant station 42 in the lift controller cabinet 70. The telescoping mast 20 is shown configured with four 98 Watt LED floodlights with photoelectric cells though alternate variations may include two, six or odd numbers of lights as well. Regardless, mast 20 MUST be completely lowered for travel/transport, however.

An optional 600, 1000, 2000 or 3500 Watt wind turbine 18 can be mounted to trailer 14, either using the same mast 20 as above or through its own, stand-alone telescopic mast pole. Like the aforementioned light tower mast, any separate mast for wind turbine 18 must be completely lowered for travel. Note that in some instances, the outdoor flood lighting and wind turbine can be combined onto a single telescoping mast.

One such wind turbine option comprises conventional a wind energy machine known as a horizontal axis style wind turbine with a plurality of blades 74. That wind energy system would mount on its tower for extending up to about 20-40 feet high when fully deployed. Wind energy is particularly useful to provide supplemental power to the system at night or during especially windy days. Conversely, during the seasonal longer hours of available solar energy generation, there would be less need/reliance on the wind energy (optional) components hereof.

The energy produced from the solar panels and/or wind system transfers to deep cycle batteries that can store the energy. Preferred batteries are industrial grade, deep-cycle, maintenance free, gel-cell batteries that do not need to be checked and do not need additional water added. Representative makers/sellers of such batteries include Deka and Concorde. Such batteries will be enclosed in a power storage cabinet 60 for keeping the batteries safe, yet functional over a set range of temperatures.

Preferably, the platform 10 further comprises a standby generator 66, such as a propane-powered, natural gas or other hydrocarbon-powered generator, along with a fuel tank 72 for storing the fuel needed to run generator 66. One representative generator system uses a storage tank 72 with a 100 lb./23 gal. capacity.

It is only intended for that generator to operate at peak for short periods of time to maximize overall efficiency and extend battery service life. If that generator had to provide additional run time to compensate for reduced wind speed or solar insolation, it still should be able to handle it with little to no additional stress. Consequently, if loads are reduced, virtually no generator usage would be required.

The Figures also show an optional kinetic charging component with its generator component 22 situated at or near the towing wheels for trailer 14. They connect to a generator 56 within a control box for the system proper.

The assembly and system of this invention should be virtually maintenance free. The trailer unit itself is a compact size and relatively lightweight for transport and deployment at most any remote location. It can be deployed, once at its end use location, by just one person. The system offers a substantial fuel savings over an equivalent fossil fuel generator standing alone.

For greater stability against potential wind damage, multiple anchoring devices are incorporated throughout. Once delivered, this assembly and system are completely operational. Unlike other known systems (described above), this invention has the added benefit of being able to commence energy storage through its photovoltaic cells and into its battery storage “packs” while being transported to its eventual end user site. The only on-site construction might involve the erection of its optional light mast, wind tower and/or telecommunications equipment, all of which are permanently attached to or erected near that end of the platform from which all electrical connections are made to its adjacent inverter.

For the comparative chart at FIG. 4, fuel costs used a generator calculation based on diesel fuel at about $4.15/gal. and propane at $2.33/gal. based on a 365 days/24 hours per day usage. The side-by-side comparison did not take into account fuel delivery or refueling costs. It was noted, however, that a standard 6 kW diesel generator might require refueling as often as 2 times/week as compared to the MP-4000's use of a 100 lb. propane tank requiring refueling only once every 3 months. With the aforementioned fuel cost savings, fuel delivery AND refueling costs, it is expected that financial payback from use of a system like that of the present invention can be achieved as quickly as 18 mos. or up to 3 years depending on its frequency of use.

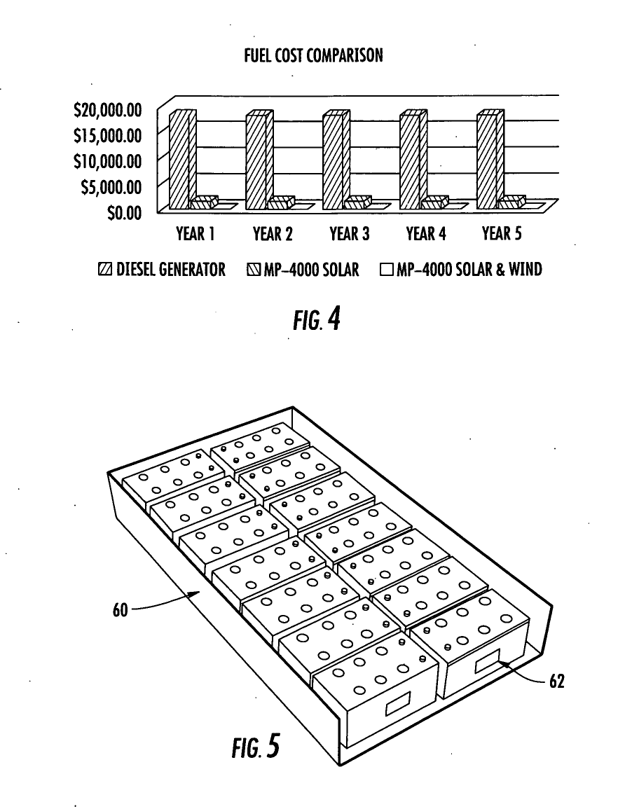

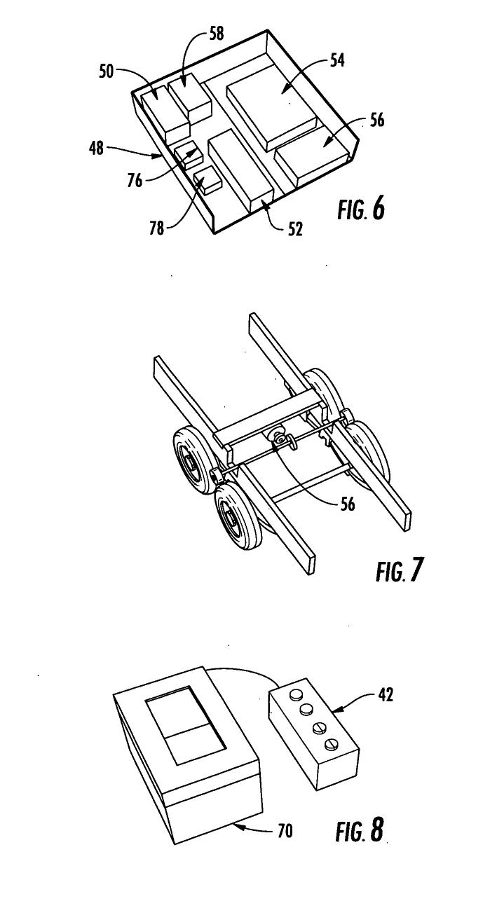

FIG. 5 schematically shows one preferred arrangement of battery storage units, in a weather resistant case/cover. FIG. 6 depicts one schematic cabinet, in perspective view, showing various subcomponent-controllers for use with the system; and FIG. 7 schematically shows one representative embodiment of kinetic generator device beneath the trailer deck, between its wheels, per one embodiment of this optional addition to this invention.

One representative model of Mobile Power Platform according to this invention consists of the following components:
1. Trailer—Used to transport the solar generator to location where power is needed. Other major components are secured to the top deck of this trailer. They include a solar panel frame system, telescoping mast system, battery cabinet, charger/inverter cabinet, lift control cabinet, generator control cabinet, photovoltaic combiner cabinet, fuel storage (single gasoline tank, single diesel tank or propane tanks) and generator/cage. One preferred trailer deck is at least 6 feet wide, (no wider than 8 feet, 6 inches) and from 8 feet to 32 feet in length for a standard tow-behind trailer, or up to 53 feet for a drop deck semi-trailer.
2. Battery Cabinet(s)—Contains 12 Volt batteries (possibly connected in series to produce 24 or 48 volts) in parallel to store energy produced by solar panels, optional wind turbine and optional kinetic generator. Each parallel battery circuit is connected to a fuse (to allow battery replacement without completely shutting down the energy storage system), then to a power distribution block (one for positive battery connections and one for negative battery connections). The power distribution blocks are connected through a conduit to a fused AC/DC connection electrical blocks in the charger/inverter cabinet(s). Battery cabinets include a temperature sensor, a thermostat and at least 2 fans to provide airflow and cooling inside the cabinet. Additional fans installed in the cabinet are optional for environments consistently operating above 90° F. A heater installed in the cabinet is optional for environments consistently operating below 32° F. The standard thermostat only runs the fans for cabinet temperatures over 90° F. and only runs the heater to keep cabinet temperatures at a minimum of 40° F.
3. Charger/Inverter Cabinet(s)—Contains the DC-to-AC inverter, the AC/DC electrical connection blocks, the photovoltaic solar charge controller, the remote communication controller, the optional wind turbine charge controller, the optional kinetic generator charge controller and the optional solar panel frame system single axis tracking controller. The DC-to-AC inverter is connected through a conduit to the electrical power safety panel to provide AC output power. Charger/inverter cabinets include a thermostat and a sealed fan/heat transfer unit (NEMA 3R rated) to provide airflow and cooling inside the cabinet. An additional sealed fan/heat transfer unit is optional for environments consistently operating above 90° F. The standard thermostat only runs the sealed fan/heat transfer units for cabinet temperatures over 80° F.
4. Lift Control Cabinet—Contains the solar panel frame lift controls, a retractable pendant station (pushbuttons and selector switch), the system status display and a system-wide emergency shutoff switch. The pendant station has a selector switch (solar array, telescoping mast, track and off position), two pushbuttons (raise and lower) and a retractable cord to extend the lift controls to a safe position away from the trailer during operation. The system status display provides information on the charge level for battery bank and operation of its charger/inverter output. The emergency shutoff pushbutton switch deactivates all power to the system. The optional telescoping mast lift controls are also contained within the cabinet. The lift controls and emergency shutoff switch are connected through a conduit to the charger/inverter cabinet AC/DC connection electrical blocks. The lift control cabinet is mounted on the deck at the front of the trailer.
5. Solar Panel Frame System—Provides the mounting for the solar panels and positioning of the solar array. The solar panel array is positioned with linear electric actuators connected to the main frame, support beams. Extendible support posts are used to provide stability for fixed positioning of the frame system. An optional single axis, tracking computer (mounted in the charger/inverter cabinet) can automatically position the frame by tracking the sun's path from east to west. The solar panels are electrically connected to a photovoltaic combiner box also mounted on the trailer deck.
6. Telescoping Mast System—An optional component that provides the height extension of the optional wind turbine, optional LED floodlights, optional security devices (cameras, motion sensors, infrared lights) or combination of any of these options. The telescoping mast system includes a pneumatic compressor, electric winch or hand crank to extend and collapse the mast. For the pneumatic controlled mast, an air compressor and electronic valve module is added. For the electric winch controlled mast, an electric winch motor is added. The pneumatic compressor and electric winch are controlled with the pendant station raise/lower pushbuttons connected to the lift control cabinet.
7. Kinetic Generator System—An optional component that charges the battery system during transport. The kinetic generator system includes a drive shaft with small wheels, a motor/generator, a clutch mechanism to engage/disengage the motor/generator and a charge controller. The small wheels make contact with the trailer wheels to turn a shaft with a gear. That gear turns a motor/generator to generate DC electrical current to a kinetic charge controller. The charge controller regulates and conditions the electrical current from the motor/generator and connects to the power storage system. The charge controller also disengages the motor/generator when the power storage system is fully charged. The motor/generator is mounted under the trailer deck and the kinetic charge controller is mounted in the charger/inverter cabinet.
8. Wind Turbine Generator System—An optional component that charges the battery system in addition to the photovoltaic solar charging system. The wind turbine generator system includes a wind turbine generator and a wind charge controller. The wind turbine generator is mounted on top of the telescoping mast and the wind charge controller is mounted in the charger/inverter cabinet.
9. LED Floodlight System—An optional component that provides lighting at night at the remote location. The LED floodlight system includes 2 or 4 LED floodlights with photo cells and a switch box to control which lights are used. The LED floodlight system is mounted on the top of the telescoping mast.
10. Standby Generator System—An optional component that automatically charges the battery system when the battery discharge level reaches a configurable charge level. The Standby Generator system includes a gasoline, diesel, propane or natural gas fueled generator, fuel storage tank(s), a generator start controller (in the generator controller cabinet) and an emergency generator shutoff pushbutton switch. The standby generator is connected to the inverter in the charger/inverter cabinet. The generator can also be disconnected from the inverter to provide additional power while fuel is available.
11. Generator Control Cabinet—Contains the generator start/stop controller and a system wide emergency shutoff switch. The emergency shutoff pushbutton switch deactivates all power in the entire system.

### EXAMPLES

The following chart shows the various models of platforms available, their specification particulars (including power outputs), and the optional additions for same.

| Features | | | | MP- | | MP- | | | | MP- |
|---|---|---|---|---|---|---|---|---|---|---|
| Options | MP-1000 | MP1000-E | MP-2000 | 2000-E | MP-4000 | 4000-E | MP-4000-T | MP-8000 | MP-32000 | 32000-3P |
| Output Power | 1000 | 1000 | 2000 | 2000 | 4000 | 4000 | 4000 | 8000 | 32000 | 30000 |
| (W) | | | | | | | | | | |
| Output | 120 | 120 | 120 | 120 | 120/240 | 120/240 | 120/240 | 120/240 | 120/240 | 120/208 |
| Voltage (V) | | | | | | | | | | |
| Trailer Deck | 8 | 12 | 16 | 20 | 24 | 28 | 24 | 30 | 42 | 42 |
| Length (ft) | | | | | | | | | | |
| Solar Panels | 4 | 4 | 8 | 8 | 16 | 16 | 16 | 30 | 100 | 100 |
| Batteries | 4 | 8 | 8 | 12 | 16 | 16 | 16 | 32 | 128 | 128 |
| Single Axis | N/A | N/A | N/A | N/A | N/A | Optional | Standard | Standard | Standard | Standard |
| Tracker | | | | | | | | | | |
| 600 W Wind | Optional | Optional | Optional | Optional | N/A | N/A | N/A | N/A | N/A | N/A |
| Turbine | | | | | | | | | | |
| 1000 W Wind | N/A | N/A | Optional | N/A | Optional | Optional | Optional | N/A | N/A | N/A |
| Turbine | | | | | | | | | | |
| 2000 W Wind | N/A | N/A | N/A | N/A | Optional | Optional | Optional | Optional | N/A | N/A |
| Turbine | | | | | | | | | | |
| 3500 W Wind | N/A | N/A | N/A | N/A | N/A | N/A | N/A | Optional | Optional | Optional |
| Turbine | | | | | | | | | | |
| 2 LED | Optional | Optional | Optional | Optional | Optional | Optional | Optional | Optional | Optional | Optional |
| Floodlight | | | | | | | | | | |
| Package | | | | | | | | | | |
| 4 LED | Optional | Optional | Optional | Optional | Optional | Optional | Optional | Optional | Optional | Optional |
| Floodlight | | | | | | | | | | |
| Package | | | | | | | | | | |
| 2000 W | Optional | Optional | Optional | Optional | N/A | N/A | N/A | N/A | N/A | N/A |
| Standby Gas | | | | | | | | | | |
| Generator | | | | | | | | | | |
| 2000 W Prop | Optional | Optional | Optional | Optional | N/A | N/A | N/A | N/A | N/A | N/A |
| Generator | | | | | | | | | | |
| 4000 W Gas | N/A | N/A | Optional | Optional | Optional | Optional | Optional | N/A | N/A | N/A |
| Generator | | | | | | | | | | |
| 4000 W Prop | N/A | N/A | Optional | Optional | Optional | Optional | Optional | N/A | N/A | N/A |
| Generator | | | | | | | | | | |
| 6500 W Tri- | N/A | N/A | N/A | N/A | Optional | Optional | Optional | Optional | N/A | N/A |
| Fuel Gen | | | | | | | | | | |
| 6500 W Diesel | N/A | N/A | N/A | N/A | Optional | Optional | Optional | Optional | N/A | N/A |
| Generator | | | | | | | | | | |
| 10000 W Tri- | N/A | N/A | N/A | N/A | N/A | N/A | N/A | Optional | N/A | N/A |
| Fuel Gen | | | | | | | | | | |
| 10000 W | N/A | N/A | N/A | N/A | N/A | N/A | N/A | Optional | N/A | N/A |
| Diesel Gen | | | | | | | | | | |
| Remote | Optional | Optional | Optional | Optional | Optional | Optional | Optional | Optional | Optional | Optional |
| Monitoring | | | | | | | | | | |
| High Wind | Optional | Optional | Optional | Optional | Optional | Optional | Optional | Optional | Optional | Optional |
| Anchor Kit | | | | | | | | | | |
| Cold Weather | Optional | Optional | Optional | Optional | Optional | Optional | Optional | Optional | Optional | Optional |
| Heater Kit | | | | | | | | | | |
| Hot Weather | Optional | Optional | Optional | Optional | Optional | Optional | Optional | Optional | Optional | Optional |
| Cooling Kit | | | | | | | | | | |
| Tripod LED | Optional | Optional | Optional | Optional | Optional | Optional | Optional | Optional | Optional | Optional |
| Light Tower | | | | | | | | | | |

Although the invention has been described in detail with particular reference to these preferred embodiments, other embodiments are also anticipated hereby.

What is claimed is:

1. A portable power system that is capable of charging energy storage batteries during transport to an end use location, said power system comprising:
a trailer that can be towed to the end use location by a vehicle, said trailer having a substantially planar top deck onto which is permanently mounted:
a retractable solar array having at least 3 photovoltaic solar panels permanently mounted on a hinged frame secured along one longitudinal end of the trailer, said solar panels connected to a DC electrical charge controller for charging a bank of DC batteries on the trailer, said hinged frame being capable of receiving energy while said solar panels are stored in an “A” configuration during transport to the end use location and for folding into a substantially flat charging configuration when fully deployed; and
a bank of DC batteries stored in a weatherproof cabinet on the trailer for receiving the electrical power collected from the solar panels and distributing the collected energy an inverter for powering one or more energy appliances connected to the system.

2. The power system of claim 1, which includes at least two rows of solar panels, with 3 or more panels in each row, the tops of both rows being fixedly hinged to each other.

3. The power system of claim 1, which is capable of storing at least about 500 watts of power for subsequent output.

4. The power system of claim 3, which is capable of storing between about 1000 to 32000 watts of power for subsequent output.

5. The power system of claim 1, which further includes a telescopic mast from which can be extended at least one of:
a rack of floodlights powered from the system; and
a rotatable wind turbine for receiving and transmitting additional power to the system.

6. The power system of claim 1, which further includes at least one of:
a plurality of stabilizing anchors; and
individually leveling trailer leg supports.

7. The power system of claim 1, which further includes an inclinometer for positioning the hinged frame to an appropriate angle for a particular geographic location and month of use.

8. The power system of claim 1, which further includes a fluid generator that can be powered by gasoline, diesel, propane or natural gas supplied from a storage tank on the trailer to additionally charge the bank of DC batteries.

9. The power system of claim 1, which further includes a kinetic generator that can be powered by rotation of a plurality of wheels during transport of the trailer to the end use location.

10. A mobile power system capable of charging energy storage batteries during transport to an end use location, said power system comprising:
a trailer that can be towed to the end use location by a vehicle, said trailer having a substantially planar top deck onto which is permanently mounted a hinged frame for holding a plurality of connected solar panels, said frame capable of hinging into an A-shape during transport of the trailer to the end use location and folding open to a substantially planar, power collecting shape after reaching the end use location, said solar panels being connected to receive and store energy during trailer transport;
a weatherproof cabinet containing a plurality of 12 volt batteries connected in series to store energy produced by the power system,
a DC-to-AC inverter connected to provide AC output power from the batteries to an outlet or energy driven device;
a retractable solar array having at least 3 photovoltaic solar panels permanently mounted on a hinged frame secured along one longitudinal end of the trailer, said solar panels connected to a DC electrical charge controller for charging a bank of DC batteries on the trailer, said hinged frame being capable of receiving energy while said solar panels are stored in an “A” configuration during transport to the end use location and for folding into a substantially flat charging configuration when fully deployed; and
a bank of DC batteries stored in a weatherproof cabinet on the trailer for receiving the electrical power collected from the solar panels and distributing the collected energy an inverter for powering one or more energy appliances connected to the system.

11. The mobile power system of claim 10, which further includes means for positioning the solar array relative sun position for a given geographic location and time of calendar year.

1. The mobile power system of claim 10, which further includes a computer tracking device for automatically repositioning the solar array in conjunction with the sun's daily traverse from east to west.

13. The mobile power system of claim 10, which further includes: a telescopic mast and a rack of floodlights powered directly from the system.

14. The mobile power system of claim 10, which further includes: a telescopic mast and a rotatable wind turbine for receiving and transmitting additional power to the system.

15. The mobile power system of claim 10, which further includes a fluid generator that can be powered by gasoline, diesel, propane or natural gas supplied from a storage tank on the trailer to additionally charge the bank of DC batteries.

16. The mobile power system of claim 10, which further includes a kinetic generator that can be powered by rotation of a plurality of wheels during transport of the trailer to the end use location.

17. A method for providing mobile power to an end use location, said method comprising:
(a) providing a transportable energy power collection system having a plurality of photovoltaic solar panels on a lightweight trailer platform, said panels being on a hinged frame that allows for the receipt and transmission of energy from said panels to a plurality of storage batteries while the platform is being transported to an end user site;
(b) transporting the platform with the energy power system and batteries disposed thereon to the end user location;
(c) connecting the system to one or more devices for providing energy stored on said plurality of batteries.

18. The method of claim 17 wherein the power system further includes a backup generator unit and a fuel storage container for that generator.

19. The method of claim 17 wherein the power system further includes uncomplicated, cost-effective means for positioning the photovoltaic solar panels to the position of the sun as it moves across the sky.
